(19) United States
(12) Patent Application Publication
(10) Pub. No.: US 2014/0064259 A1
(43) Pub. Date: Mar. 6, 2014

(54) METHOD OF MANAGING CONTEXT TABLE FOR COMPRESSION OF IPV6 HEADER BASED ON CONTEXT IN WIRELESS MESH NETWORK

(71) Applicant: Electronics and Telecommunications Research Institute, Daejeon (KR)

(72) Inventors: Jeehoon LEE, Seoul (KR); Jongsoo JEONG, Daejeon (KR); SEON-TAE KIM, Daejeon (KR); PYEONG SOO MAH, Daejeon (KR)

(73) Assignee: Electronics and Telecommunications Research Institute, Daejeon (KR)

(21) Appl. No.: 13/960,422

(22) Filed: Aug. 6, 2013

(30) Foreign Application Priority Data
Aug. 28, 2012 (KR) 10-2012-0094562

(51) Int. Cl. H04L 29/06

(52) U.S. Cl. CPC H04L 69/04
USPC 370/338

(57) ABSTRACT

A method of managing a context table for the compression of an IPv6 header based on a context in a wireless mesh network includes: determining, by a boundary router for coupling an external network and a Low-power and Lossy Network (LLN), a score by taking information on the traffic of a packet transmitted by an external host into consideration; assigning, by the boundary router, a Context ID (CID) to the prefix of the packet based on the determined score and registering the CID with a context table: and sending, by the boundary router, the packet of context registered with the context table to all nodes of the LLN.

### CROSS-REFERENCES TO RELATED APPLICATIONS

The present application claims priority under 35 U.S.C 119(a) to Korean Application No. 10-2012-0094562, filed on Aug. 28, 2012, in the Korean Intellectual Property Office, which is incorporated herein by reference in its entirety set forth in full.

### BACKGROUND

An exemplary embodiment of the present invention relates to a method of managing a context table for the compression of an IPv6 header based on a context in a wireless mesh network, and more particularly, to a method of managing a context table for the compression of an IPv6 header based on a context in a wireless mesh network, which can increase a ratio of compressed packets by replacing and updating the context of a context table, used to compress an address in an IPv6 over Low-power Personal Area Network (6LoWPAN), according to score.

As known, a low-power and lossy network (hereinafter referred to as an LLN) that complies with a standard, such as IEEE 802.15.4, requires interoperarability with the existing Internet. In order to satisfy the requirement, an Internet Protocol (IP) being used in the existing Internet has to be applied to the LLN.

In particular, it is necessary to use IPv6 instead of IPv4 having an address exhaustion problem because a low-power network, such as an LLN, consists of sets of numerous nodes.

It is however inappropriate to simply apply IPv6 to an LLN having serious resource limits because the size of an IPv6 header is 40 bytes and a minimum transmission packet size necessary for IPv6 is 1280 octets.

In order to solve this problem, IETF has standardized an IPv6 over Low-power Personal Area Network (6LoWPAN) adaptation layer so that IPv6 can be applied to an LLN.

The 6LoWPAN adaptation layer is placed between the network layer and the link layer and configured to compress or decompress the header of a packet. In particular, the 6LoWPAN is advantageous in that it can increase the compression ratio because the IPv6 address field that occupies most of areas in the IPv6 header can be compressed.

FIG. 1 shows a header data format of a common IPv6 packet.

As shown in FIG. 1, the length of an address for the IPv6 packet is 16 bytes and a total header size has a data capacity of 40 bytes. Since 32 bytes, that is, about 80% of the total header size, are allocated to a source address and a destination address, the address must be compressed in order to reduce the length of the header effectively.

FIG. 2 shows a state in which an exemplary address of IPv6 is configured based on the IPv6 header data format shown in FIG. 1.

As illustrated in FIG. 2, the configuration of the IPv6 address allocated to each node in an LLN includes a prefix having a length of 64 bits and an interface ID that is subsequent to the prefix and has a length of 64 bits.

Meanwhile, when the header of a packet is compressed in a 6LoWPAN, a stateless header compression method and a stateful header compression method are used. The stateless header compression method is used when an IPv6 address is a link-local address. In this method, only a prefix part is removed simply.

In contrast, the stateful header compression method is an address compression method based on a context and used when an IPv6 address is a global address. In this method, a prefix is compressed using a context table.

In this case, since nodes that form an LLN communicate with an external host using a global address, the global address must be compressed using the stateful compression method as a header compression method.

FIG. 3 shows a state in which a conventional boundary router compresses the address of data received from an external host using a context table.

As shown in FIG. 3, when an external host sends data to the nodes of an LLN, a boundary router compresses the prefix part of the address of the external host using a context table. If the context table is used, not only the prefix, but also an IID part corresponding to the remaining 64-bit length can be additionally compressed using the existing 6LoWPAN compression technology.

The boundary router that performs a routing function between the LLN and an external network maintains and manages the context table, maps the prefix of the external host on which stateful compression will be performed to a Context ID (CID) using the prefix as context, and transfers context, updated by the mapping with the CID, to all the nodes of the LLN for synchronization.

Meanwhile, the CIDs registered with the context table are unique values for identifying respective entries, and each of the CIDs has a length of 4 bits. Accordingly, a maximum of 16 prefixes can be registered with the context table because there are 16 IDs from 0 to 15.

Related technology includes Korea Patent Laid-Open Publication No. 2007-0008436 (Jan. 17, 2007) entitled ‘Gateway and Interoperability Method of 6LoWPAN’. This patent includes IPv6 header compression method of boundary gateway. The gateway that is located between 6LoWPAN and external networks uses a mapping table to compress or decompress IPv6 header. However, the mapping table is not managed according to a network traffic pattern.

A boundary router for coupling an external network and an LLN registers the prefix of an external host with a context table and compresses a global address. However, since the number of prefixes that can be registered with the context table is limited to a maximum of 16, packets that are transmitted by hosts not registered with the context table are inevitably transmitted in the state in the addresses of the packets are not compressed. If packets generated from an external host not registered with a context table are larger than packets a host registered with the context table, there are problems in that the context use efficiency of the context table is inevitably lowered and a ratio of compressed packets within an LLN is inevitably reduced.

In order to solve the problems, a network manager must directly access a boundary router and update and modify the context of a context table, but this method is inconvenient.

In order to improve the packet address compression efficiency of an LLN even without an inconvenient update task by a network manager and in order for a boundary router to efficiently use a context table, there is an urgent need for technology which allows a boundary router to automatically select the prefix of an external host that generate lots of packets within an LLN based on a specific determination condition and thus can efficiently manage a context table.

### SUMMARY

An embodiment of the present invention relates to a method of managing a context table for the compression of an IPv6 header based on a context in a wireless mesh network, which can manage a context table efficiently and improve a ratio of compressed packets within an LLN by assigning a score to context by taking the distance of a destination node and whether multicast transmission has been performed or not into consideration and registering the context with a context table in order of higher score when communication is performed between an external network and an LLN in a 6LoWPAN.

In one embodiment, a method of managing a context table for the compression of an IPv6 header based on a context in a wireless mesh network includes a first step of, by a boundary router for coupling an external network and a Low-power and Lossy Network (LLN), determining a score by taking information on the traffic of a packet transmitted by an external host into consideration, a second step of, by the boundary router, assigning a Context ID (CID) to the prefix of the packet based on the determined score and registering the CID with a context table, and a third step of, by the boundary router, sending the packet of context registered with the context table to all nodes of the LLN.

In the first step, the information on the traffic of the packet taken into consideration in order for the boundary router to determine the score includes the number of hops from the boundary router to a destination node for the packet generated from the external host, whether multicast transmission has been performed or not, and the transfer cycle of the packet.

In the first step, the score is determined by an equation S_{A}=D+(16/P_{A}), wherein S_{A} denotes the score of a specific external host, D denotes the number of hops from the boundary router to the destination node, and P_{A} denotes the packet transfer cycle of the specific external host.

In the second step, if a memory space allocated to the context table is in a full state in which all contexts are fully registered with the memory space, the context of the packet having the determined score is registered with a reserved table.

The second step includes, by the boundary router, comparing the score of the context registered with the context table with the score of the context registered with the reserved table and exchanging a context having a high score in the reserved table and a context having a low score in the context table, if the score of the context registered with context table is smaller than the score of the context registered with the reserved table.

In the second step, when contexts are registered with the reserved table starting from the context having the low score value in the context table, the boundary router registers only a context and score with the reserved table, and when contexts are registered with the reserved table starting from the context having the high score in the context table, the boundary router maps CIDs assigned to contexts to be exchanged and allocates the CIDs to corresponding contexts and scores.

The second step includes, by the boundary router, determining whether the context including the determined score is a context already registered with the context table or not and updating the score of the already registered context by increasing the score of the already registered context by the determined score, if, as a result of the determination, the context including the determined score is determined to be the already registered context.

### BRIEF DESCRIPTION OF THE DRAWINGS

The above and other aspects, features and other advantages will be more clearly understood from the following detailed description taken in conjunction with the accompanying drawings, in which:

FIG. 1 shows a header data format of a common IPv6 packet;

FIG. 2 shows a state in which an exemplary address of IPv6 is configured based on the IPv6 header data format shown in FIG. 1;

FIG. 3 shows a state in which a conventional boundary router compresses the address of data received from an external host using a context table;

FIG. 4 shows the configuration of a network system for implementing a method of managing a context table for the compression of an IPv6 header based on a context in a wireless mesh network in accordance with an embodiment of the present invention;

FIG. 5 shows the construction of a boundary router that is responsible for a function of managing a context table in the method of managing a context table for the compression of an IPv6 header based on a context in a wireless mesh network in accordance with an embodiment of the present invention;

FIG. 6 illustrates a state in which contexts are exchanged between a context table and a reserved table based on a score in the method of managing a context table for the compression of an IPv6 header based on a context in a wireless mesh network in accordance with an embodiment of the present invention; and

FIG. 7 is a flowchart illustrating a process of updating a context table in the method of managing a context table for the compression of an IPv6 header based on a context in a wireless mesh network in accordance with an embodiment of the present invention.

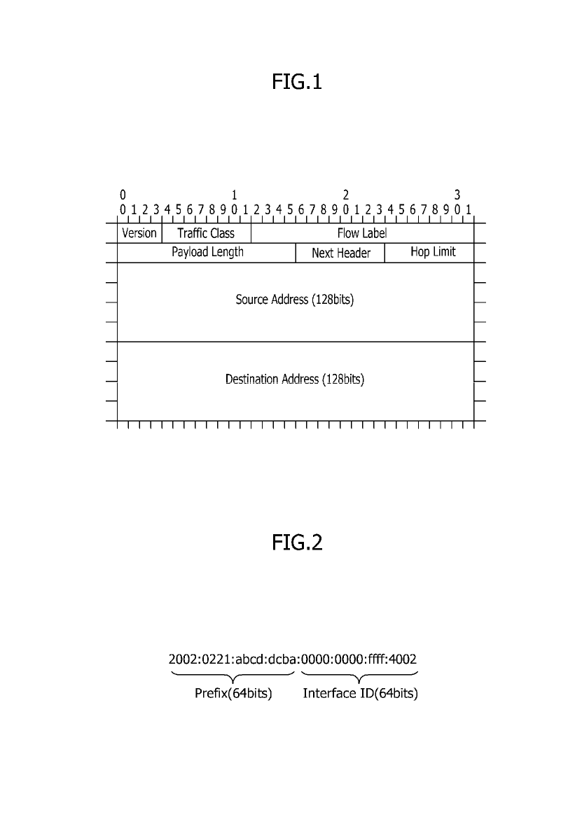

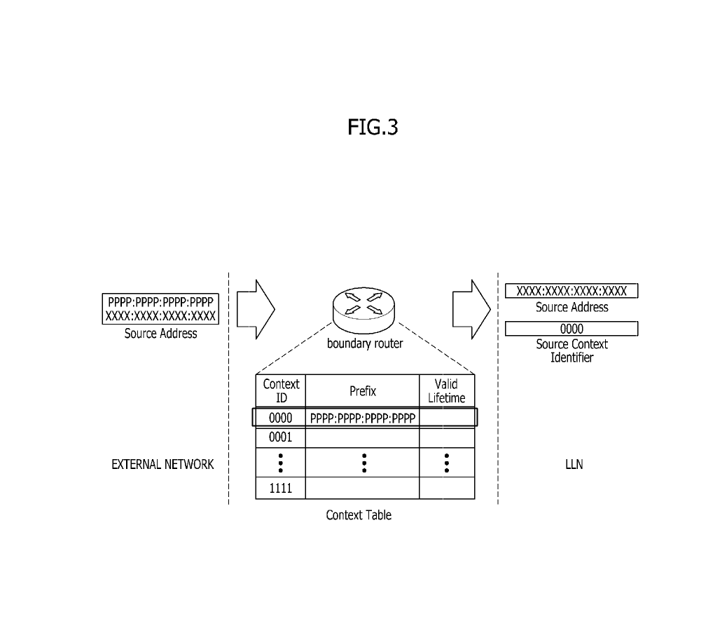

### DESCRIPTION OF SPECIFIC EMBODIMENTS

Hereinafter, embodiments of the present invention will be described with reference to accompanying drawings. However, the embodiments are for illustrative purposes only and are not intended to limit the scope of the invention.

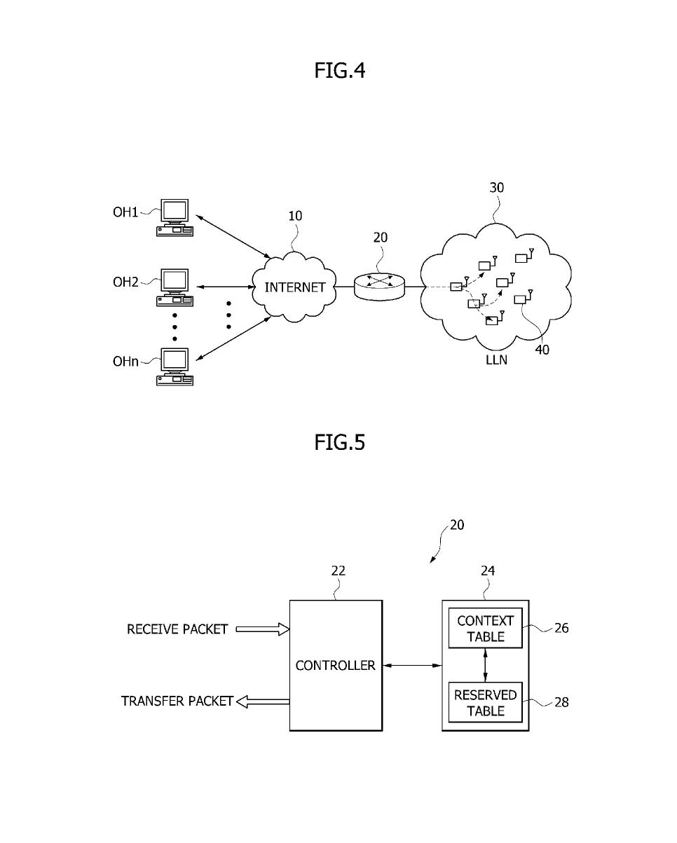

FIG. 4 shows the configuration of a network system for implementing a method of managing a context table for the compression of an IPv6 header based on a context in a wireless mesh network in accordance with an embodiment of the present invention.

As shown in FIG. 4, the network system for implementing the method of managing a context table for the compression of an IPv6 header based on a context in a wireless mesh network in accordance with the present invention includes a plurality of external hosts OH1˜OHn, the Internet 10, a boundary router 20, and an LLN 30 including a plurality of nodes 40.

The plurality of external hosts OH1˜OHn send data packets, each having an address within a header based on IPv6, to the nodes 40 of the LLN 30 over the Internet 10.

The Internet 10 is an external network connected to the plurality of external hosts OH1˜OHn so that the Internet 10 is capable of multimedia network communication with the plurality of external hosts OH1˜OHn. The Internet 10 transfers data packets from a specific external host to the nodes 40 of the LLN 30 via the boundary router 20.

The boundary router 20 performs a function of registering the prefixes of packets, transmitted by the plurality of external hosts OH1˜OBn via the Internet 10, with a context table and transferring the packets to the destination nodes of the LLN 30. In order to increase a ratio of compressed packets, the boundary router 20 assigns a score to a prefix depending on a traffic occurrence state for the packet communication of each external host and manages the score.

The boundary router 20 has to determine that the prefix of what external host will be registered with the context table in order to increase a ratio of compressed packets. The boundary router 20 selects an external host that generates the greatest traffic for the LLN 30. To this end, the boundary router 20 assigns a score to a prefix depending on the traffic of each host and preferentially registers a prefix having a high score with the context table.

Meanwhile, the score can be determined by taking all the number of hops from the boundary router 20 to a destination node for packets generated from an external host, whether multicast transmission has been performed or not, and information on the traffic of transfer packets, such as a the transfer cycle of a packet, into consideration.

The plurality of nodes 40 receives packet data from the external hosts OH1˜OBn having context that has been changed by the boundary router 20.

FIG. 5 shows the construction of the boundary router 20 that is responsible for a function of managing a context table in the method of managing a context table for the compression of an IPv6 header based on a context in a wireless mesh network in accordance with an embodiment of the present invention.

As shown in FIG. 5, the boundary router 20 includes a controller 22 and table memory 24 equipped with a context table 26 and a reserved table 28.

The controller 22 receives packet data from the external hosts OH1˜OBn, calculates the number of hops up to the destination nodes 40 of the LLN 30 and the transfer cycle of each packet, calculates scores for the packets, assigns a Context IDentification (CID) to the context of each packet, registers the contexts of the packets with the context table 26 of the table memory 24 based on the calculated scores, and manages the contexts.

The controller 22 of the boundary router 20 performs management according to a change of a score for context registered with the context table 26. Each score is used as a comparison value for replacing context, and an expression for the score can be represented by Equation 1 below.

S_{A}=D+(16/P_{A}) [Equation 1]

In Equation 1, S_{A} denotes the score of a specific external host A, D denotes the number of hops from the boundary router 20 to a destination node, and P_{A} denotes the packet transfer cycle of the specific external host A.

The controller 22 of the boundary router 20 updates a score according to Equation 1 whenever a packet is received from an external host. The score is increased in proportion to the distance of the destination node because the number of hops D is increased according to an increase in the distance of the destination node.

Furthermore, if the packet is for multicast transmission, the score is increased because the number of hops D is a value to which the number of hops of all the destination nodes is added.

Furthermore, the score is accumulated according to Equation 1 whenever traffic is generated from the external hosts OH1˜OBn. The score can be increased in a node having a shorter packet transfer cycle.

Meanwhile, if contexts are registered with the entire registration space allocated to the context table 26, the controller 22 can register context not registered with the context table 26, together with a score, with the reserved table 28.

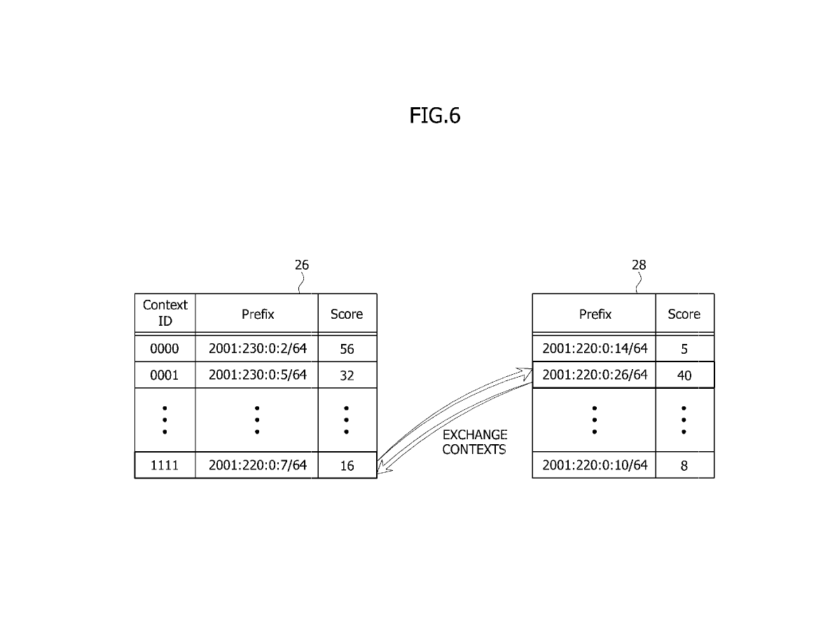

FIG. 6 illustrates a state in which contexts are exchanged between the context table 26 and the reserved table 28 based on a score in the method of managing a context table for the compression of an IPv6 header based on a context in a wireless mesh network in accordance with an embodiment of the present invention.

As shown in FIG. 6, the scores of prefixes stored in the reserved table 28 are continuously compared with scores assigned to contexts stored in the context table 26. If, as a result of the comparison, a change condition is satisfied, corresponding contexts can be exchanged and registered with the context table 26.

That is, if the score of a prefix stored in the reserved table 28 is greater than the smallest score stored in the context table 26, the prefix stored in the reserved table 28 is replaced with a prefix having the smallest score stored in the context table 26.

For example, referring to FIG. 6, assuming that a prefix having the smallest value in the context table 26 is “2001:220:0:7/64”, a score assigned to the prefix having the smallest value in the context table 26, that is, 16, is smaller than a score assigned to a prefix “2001:220:0:26/64” in the reserved table 28, that is, 40. Thus, the prefix “2001:220:0:26/64” in the reserved table 28 is mapped to the CID “1111” of the prefix having the smallest value in the context table 26 and registered with the context table 26, whereas the prefix in the CID “1111” in the context table 26 is moved to the reserved table 28.

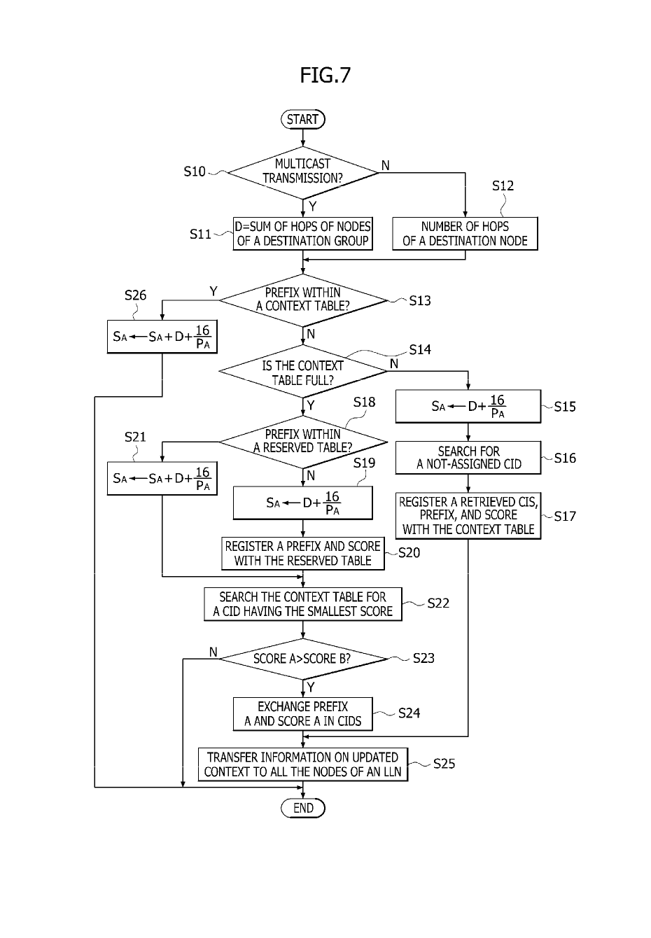

The method of managing a context table for header compression based on a context in accordance with the present invention is described in detail below with reference to a flowchart of FIG. 7.

FIG. 7 is a flowchart illustrating a process of updating a context table in the method of managing a context table for the compression of an IPv6 header based on a context in a wireless mesh network in accordance with an embodiment of the present invention.

First, the controller 22 of the boundary router 20 for coupling the Internet 10 and the LLN 30 determines whether a packet transmitted from the plurality of external hosts OH1˜OHn (hereinafter commonly designated as an external host A) is for multicast transmission or not at step S10. If, as a result of the determination, the packet is determined to be for multicast transmission, the controller 22 sets the number of hops D up to a destination node as a value to which the number of hops D of all the destination nodes is added at step S11.

In contrast, if, as a result of the determination at step S10, the packet is determined not to be for multicast transmission, the controller 22 of the boundary router 20 sets the number of hops D up to a destination node as the number of hops from the boundary router 20 to the destination node at step S12.

Next, the controller 22 of the boundary router 20 determines whether or not the prefix of the packet is a prefix to which a CID has already been assigned and which has already been stored in the context table 26 at step S13.

If, as a result of the determination at step S13, the prefix of the packet is determined not to be a prefix which has already been stored in the context table 26, the controller 22 of the boundary router 20 determines whether or not a memory space allocated to the context table 26 is in a full state in which all prefixes are fully registered with the memory space at step S14.

If, as a result of the determination at step S14, the memory space allocated to the context table 26 is determined not to be in the full state, the controller 22 of the boundary router 20 calculates the number of hops D up to the destination node and the transfer cycle of the packet in accordance with Equation 1 at step S15, searches for a CID not assigned in the context table 26 at step S16, and registers a CID assigned as a result of the search, a corresponding prefix, and a corresponding score with the context table 26 at step S17.

However, if, as a result of the determination at step S14, the memory space allocated to the context table 26 is determined to be in the full state, the controller 22 of the boundary router 20 determines whether the prefix of the packet is a prefix already registered with the reserved table 28 or not at step S18.

If, as a result of the determination at step S18, the prefix of the packet is determined not to be a prefix already registered with the reserved table 28, the controller 22 of the boundary router 20 calculates the number of hops D up to the destination node and the transfer cycle of the packet in accordance with Equation 1 at step S19 and registers a calculated score, together with the prefix, with the reserved table 28 at step S20.

However, if, as a result of the determination at step S18, the prefix of the packet is determined to be a prefix already registered with the reserved table 28, the controller 22 of the boundary router 20 updates a score calculated in accordance with Equation 1 by adding the calculated score to an already calculated score at step S21.

Next, in the state in which the memory space allocated to the context table 26 are full of all prefixes, the controller 22 of the boundary router 20 searches for a CID having the smallest score S_{B}, from among the prefixes registered with the context table 26, at step S22 and determines whether or not the score S_{A} of a prefix registered with the reserved table 28 is greater than the smallest score S_{B} of a prefix registered with the context table 26 by comparing the smallest score S_{B} of the prefix with the score S_{A} of the prefix at step S23.

If, as a result of the determination at step S23, the score S_{A} of the prefix registered with the reserved table 28 is determined to be greater than the smallest score S_{B} of the prefix registered with the context table 26, the controller 22 of the boundary router 20 replaces the prefix and score registered with the context table 26 with the prefix and score registered with the reserved table 28 by mapping the CID, allocated to the prefix having the smallest score in the context table 26, to the CID allocated to the prefix having the score of the prefix registered with the reserved table 28 at step S24. Here, the prefix having the smallest score in the context table 26 is moved to the reserved table 28 and registered therewith.

Next, the boundary router 20 transfers packet data including information on the updated context to all the nodes 40 of the LLN 30 at step S25.

Meanwhile, if, as a result of the determination at step S13, the prefix of the packet is determined to be a prefix which has already been stored in the context table 26, the controller 22 of the boundary router 20 updates a score calculated in accordance with Equation 1 by increasing an already calculated score as the calculated score is registered with the context table 26 at step S26.

In the present invention described as above, in a traffic scenario, such as that shown in Table 1, a case where the context management method of the boundary router 20 is applied and a case where the context management method of the boundary router 20 is not applied are demonstrated below.

TABLE 1

| | | NUMBER OF PACKETS |
|---|---|---|
| | TRANSFER | TRANSMITTED FOR 10 |
| PREFIX | CYCLE | MINUTES |
| #0 | 20 | 30 |
| #1 | 20 | 30 |
| #2 | 40 | 15 |
| #3 | 10 | 60 |

In accordance with Table 1, in order to simplify the scenario, it is assumed that only three prefixes can be registered with a context table and data is transmitted by four external hosts #0˜#3. It is also assumed that the external hosts send the data to destination nodes having the same number of hops in unicast and, if a packet header is compressed by the context table, 60 bits per packet are compressed because a prefix having a length of 64 bits is mapped to a 4-bit CID.

In the traffic scenario illustrated in Table 1, if the prefix management method of the boundary router 20 according to the present invention is not applied, the following results, such as Table 2, are obtained.

TABLE 2

| | | TOTAL AMOUNT OF |
|---|---|---|
| CONTEXT ID | PREFIX | COMPRESSED DATA (BITS) |
| 00 | #0 | 1800 |
| 01 | #1 | 1800 |
| 10 | #2 | 900 |

In accordance with Table 2, if the prefixes are registered with a common context table in order of #0˜#3, the prefixes #0, #1, and #2 are registered with the common context table and corresponding packets are compressed, but packets corresponding to the prefix #3 are transmitted without address compression.

In contrast, if the context table management method according to the present invention is applied, the following results, such as Table 3, are obtained.

TABLE 3

| | | TOTAL AMOUNT OF |
|---|---|---|
| CONTEXT ID | PREFIX | COMPRESSED DATA (BITS) |
| 00 | #0 | 1800 |
| 01 | #1 | 1800 |
| 10 | #3 | 3600 |

In accordance with Table 3, since a prefix having a shorter transfer cycle, from among packet data, has a higher score, the prefixes #2 and #3 are exchanged and thus the prefixes #0, #1, and #3 are registered with the context table. From Table 3, it can be seen that, if traffic having the above scenario is generated for 10 minutes, additional 2700 bits can be further compressed in the total amount of compressed data, as compared with a case where the context table is not managed as in Table 2.

In accordance with the present invention, the boundary router between an external network and the LLN preferentially registers the prefix of an external host that generates the largest number of packets within the LLN with a context table. To this end, a score for each prefix is calculated by taking the distance of a destination node, whether multicast transmission has been performed or not, and a packet transfer cycle into consideration, the calculated scores are compared with each other, and context registered with the context table and context registered with a reserved table are exchanged based on a result of the comparison. Accordingly, a larger number of packet headers can be compressed within the LLN. In the case of the LLN, to reduce the number of packets to be transmitted is important because the LLN has a high data loss rate. In this case, the number of packets to be transmitted can be reduced because packet fragmentation is less generated. Furthermore, power consumption for the transmission and reception of data can be reduced even in each node within the LLN.

Furthermore, in accordance with the present invention, the boundary router can operate efficiently for a long time even without the intervention of a network manager because the boundary router itself maintains and manages a context table.

The embodiments of the present invention have been disclosed above for illustrative purposes. Those skilled in the art will appreciate that various modifications, additions and substitutions are possible, without departing from the scope and spirit of the invention as disclosed in the accompanying claims.

What is claimed is:

1. A method of managing a context table for a compression of an IPv6 header based on a context in a wireless mesh network, the method comprising:
determining, by a boundary router for coupling an external network and a Low-power and Lossy Network (LLN), a score by taking information on a traffic of a packet transmitted by an external host into consideration;
assigning, by the boundary router, a Context ID (CID) to a prefix of the packet based on the determined score and registering the CID with a context table; and
sending, by the boundary router, the packet of context registered with the context table to all nodes of the LLN.

2. The method of claim 1, wherein in determining the score, the information on the traffic of the packet taken into consideration in order for the boundary router to determine the score comprises a number of hops from the boundary router to a destination node for the packet generated from the external host, whether multicast transmission has been performed or not, and a transfer cycle of the packet.

3. The method of claim 2, wherein in determining the score, the score is determined by an equation S_{A}=D+(16/P_{A}),
wherein S_{A} denotes a score of a specific external host, D denotes the number of hops from the boundary router to the destination node, and P_{A} denotes the packet transfer cycle of the specific external host.

4. The method of claim 1, wherein in assigning the CID, if a memory space allocated to the context table is in a full state in which all contexts are fully registered with the memory space, the context of the packet having the determined score is registered with a reserved table.

5. The method of claim 4, wherein the assigning the CID comprises:
by the boundary router, comparing the score of the context registered with the context table with the score of the context registered with the reserved table, and
by the boundary router, exchanging a context having a high score in the reserved table and a context having a low score in the context table, if the score of the context registered with context table is smaller than the score of the context registered with the reserved table.

6. The method of claim 5, wherein in assigning the CID,
when contexts are registered with the reserved table starting from the context having the low score value in the context table, the boundary router registers only a context and score with the reserved table, and
when contexts are registered with the reserved table starting from the context having the high score in the context table, the boundary router maps CIDs assigned to contexts to be exchanged and allocates the CIDs to corresponding contexts and scores.

7. The method of claim 1, wherein the assigning the CID comprises:
by the boundary router, determining whether the context including the determined score is a context already registered with the context table or not, and
by the boundary router, updating a score of the already registered context by increasing the score of the already registered context by the determined score, if, as a result of the determination, the context including the determined score is determined to be the already registered context.
